(19) United States
(12) Patent Application Publication
(10) Pub. No.: US 2008/0114688 A1
(43) Pub. Date: May 15, 2008

(54) SYSTEMS AND METHODS FOR PROVIDING BUNDLES OF RIGHTS

(75) Inventors: Ronald Martinez, San Francisco, CA (US); Chris Theodore Kalaboukis, Los Gatos, CA (US); Joseph Kent Siino, Berkeley, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: YAHOO! INC., SUNNYVALE, CA (US)

(21) Appl. No.: 11/735,395

(22) Filed: Apr. 13, 2007

Related U.S. Application Data
(63) Continuation-in-part of application No. 11/560,320, filed on Nov. 15, 2006.

(51) Int. Cl. H04L 9/00

(52) U.S. Cl. 705/51

(57) ABSTRACT

Methods and systems of providing a bundle of rights is disclosed herein. Data that defines a rights bundle is received at a rights engine. The data that defines the rights bundle is indicative of access rights and obligations with respect to any content item to which the bundle of rights is applied. The rights bundle is stored in a rights database. The rights database is accessible to the rights holder to retrieve the rights bundle and apply the rights bundle to a content item previously received from the rights holder.

### RELATED APPLICATION

This Application is a continuation in part of U.S. patent application Ser. No. 11/560,320, filed Nov. 15, 2006, and entitled RIGHTS ENGINE., the contents of which are incorporated by reference herein.

### BACKGROUND

1. Field

This disclosure relates to rights management system, and in particular, to a rights engine for receiving and distributing rights associated to content items.

2. General Background

Business practices and information infrastructure relating to handling of rights, particularly media rights, are outdated and constitute an impediment to business and commerce for all participants. Conventional methods are based upon a hierarchical manufacturing model. In that model, rights holders are at the top of the hierarchy, and create and also obtain rights in content items. The content items are licensed through established channels to large content consumers (e.g. distributors and retailers) using individually crafted and negotiated licenses. For small content consumers (e.g. individual users), however, associated rights agreements are generally one-size-fits-all agreements that limit the small content consumer to use on specified devices and in specified territories.

Current systems do not provide a scalable infrastructure that meets the requirements of contemporary and emerging rights creation and usage. This results in lost economic opportunity, customer satisfaction, and cultural enrichment. While content consumers have circumvented legacy rights processes (much as the Internet itself is designed to route information traffic around physical disasters) only a well-formed, contemporary, and extensible rights infrastructure can eliminate the underlying problem.

### SUMMARY

In one aspect, there is a method of providing a bundle of rights. Data that defines a rights bundle is received at a rights engine. The data that defines the rights bundle is indicative of access rights and obligations with respect to any content item to which the bundle of rights is applied. The rights bundle is stored in a rights database. The rights database is accessible to the rights holder to retrieve the rights bundle and apply the rights bundle to a content item previously received from the rights holder.

In another aspect, content consumers are provided with the content item according to the terms of the bundle of rights. In another aspect, the content item is received either as location indicator indicative of a network address where a content item is located or as data representative of the content item. The content item or the location indicator can be stored in association with the rights bundle.

In a further aspect, the bundle of rights can be applied to one or more content items such that when a content consumer receives the one or more content items. The consumer can access the one or more content items according to terms of the rights bundle.

In a further aspect, the bundle of rights includes digital rights management terms, an indication of what permissible uses are available, and/or an obligation to display advertisements, links, licenses authorship attribution, rights holder attribution, copyright notices, or tags. In addition, the bundle of rights can include a license to use to content item.

In a further aspect, the access rights include a geographical limitation, an indication of a rendering device limitation, and include an indication of a limited period of access. The content item can be a literary work, an intellectual property right, an electronic music file, or an electronic video file.

In another aspect, there is a system of providing content to consumers comprising a rights engine and a rights database. The rights engine receives data that defines a rights bundle. The data that defines the rights bundle is indicative of access rights and obligations with respect to any content item to which the bundle of rights is applied. The rights database stores the rights bundle. The rights holder can access the rights database and apply the rights bundle to a content item being received from the rights holder.

### DRAWINGS

The features and objects of alternate embodiments of the present disclosure will become more apparent with reference to the following description taken in conjunction with the accompanying drawings of various examples wherein like reference numerals denote like elements and in which:

FIGS. 1A-1B depict a component diagram of a system for submitting and retrieving content rights according to one embodiment.

FIG. 2 depicts a component diagram of a computing device according to one embodiment.

FIG. 3 depicts a flow diagram of a process for submitting content rights to a rights provider according to one embodiment.

FIG. 4 depicts an example of a user interface for providing a rights model selection to a rights holder according to one embodiment.

FIG. 5 depicts an example of a user interface for identifying a content item according to one embodiment.

FIG. 6 depicts an example of a user interface for creating a rights bundle according to one embodiment.

FIG. 7 depicts an example of a user interface for entering a term of a rights bundle according to one embodiment.

FIG. 8 depicts an example of a user interface for entering obligations related to a rights bundle according to one embodiment.

FIG. 9 depicts an example of a user interface for entering permitted territories information related to a rights bundle according to one embodiment.

FIG. 10 depicts an example of a user interface for entering permitted devices, uses and restriction information related to a rights bundle according to one embodiment.

FIG. 11 depicts an example of a user interface for selecting additional definitions for a rights bundle according to one embodiment.

FIG. 12 depicts a flow diagram of a process for searching content items and associated rights according to one embodiment.

FIG. 13 depicts an example of a user interface for searching content items and associated rights according to one embodiment.

FIG. 14 depicts an example of a user interface for viewing a list of available content items according to one embodiment.

FIG. 15 depicts an example of a user interface for viewing a list of available rights bundles according to one embodiment.

FIG. 16 depicts an example of a user interface for viewing a list of available rights holders according to one embodiment.

FIG. 17 depicts an example of a user interface for entering rights holder information according to one embodiment.

### DETAILED DESCRIPTION

Methods and systems of providing a normalized, searchable rights engine and repositories are disclosed herein. The rights engine can permit registration of rights under multiple rights regimes for any content item. As used herein a content item refers to any media, software, service, tool, or concept that can be distributed to a consumer based on an assigned right. Likewise, as used herein, rights can encompass a set of permissions, freedoms, restrictions, and/or obligations to access and/or use a content item.

In an embodiment, one or more rights can be registered in association with a content item in order to provide access to content consumers. Large traditional rights holder companies as well as end users, affiliates, distributors, business units within a given company, may all register rights associated to any content item with the rights engine. Additionally, the same rights holder that registers a right and associated content can become a content consumer who can access the content items under varying levels of authority. All rights may be searched or tagged, either by providers or consumers. Advertisements may also be associated with rights, as well as a variety of commerce models, including pay per item, pay per view, subscription, and so on.

In one embodiment, the rights engine system described herein permits the networked, digital medium rights creation, distribution, and consumption to follow a cyclical course. A rights cycle starts when the rights are created, acquired, and/or licensed. Rights creators can then become consumers, which in turn can create new content items. As such, any consumer receiving rights-governed content can re-use the content according to the rights associated with such content. For example, the consumer may reuse the content on a blog, podcast, video, or personal site, consistent with rights embodied in the rights engine.

In another embodiment, the rights engine can permit rights holders to determine which devices can render the content items. For example, media is consumed on an ever-expanding set of devices. Thus, digital video, for instance, may be experienced on a television, a computer, and then on a mobile phone or portable media player. A rights holder can pre-select which of these devices are permitted to render the digital video. Thereafter, a provider of the media itself may provide alternative formatting consistent with the playback requirements of the various player devices.

Media portions are also fully supported, enabling recombination of various content items into a new content item which may in turn be provided to the rights engine with new associated rights.

As such, the system and method disclosed herein, supports remixed content, for both content originated for remix purposes, and for that which has been repurposed. For example, a film studio could digitize video clips from a film library, and push the video clips into the rights engine. The rights holder can require a fee when the video clips are used in another work. Alternatively, the rights holder can make the clips available without charge as a marketing tool. Tags associated with such remixable content may be found and ads may be delivered alongside the content when the content is viewed or experience online. Thus, consumers can find and incorporate remixable media into new composite works using video or audio remixers, or podcast creators, websites, or other media forms. Remixed portions of content items can include identifiers used to reference information about each content portion, including payment, rights holder information, other content related via tags, and so on.

Accordingly, the system and method disclosed herein allows for easy and secure access to content items. For example, rather than entering into complex negotiations to enable a large Internet service provider or retailer to distribute and resell video or audio content, a rights holder can simply submit the relevant content to the rights engine on his own initiative, setting terms and payment requirements desired by the rights holder. A right provider that manages the rights engine can then make the submitted content item available exactly as offered by the rights holder. When a content item is sold, the rights provider remits payment to the rights holder according to pre-established payment information for the rights holder. In other words, complete retail offerings for varied territories, devices, and content types can be implemented automatically with little or no human inventory management or agreement constructions. The agreements are provided according to stored agreements previously submitted by the rights holder. Moreover, the same mechanisms are available for large rights-producing companies as well as small companies and individual consumers. Each can push rights and references to associated content to the rights engine.

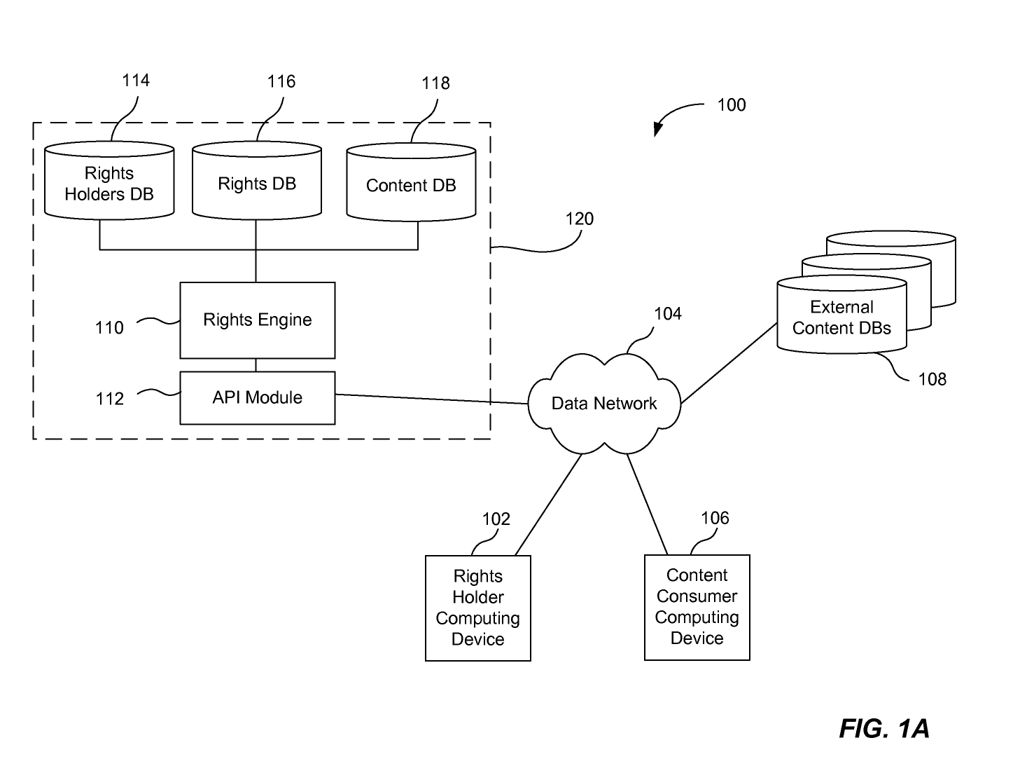

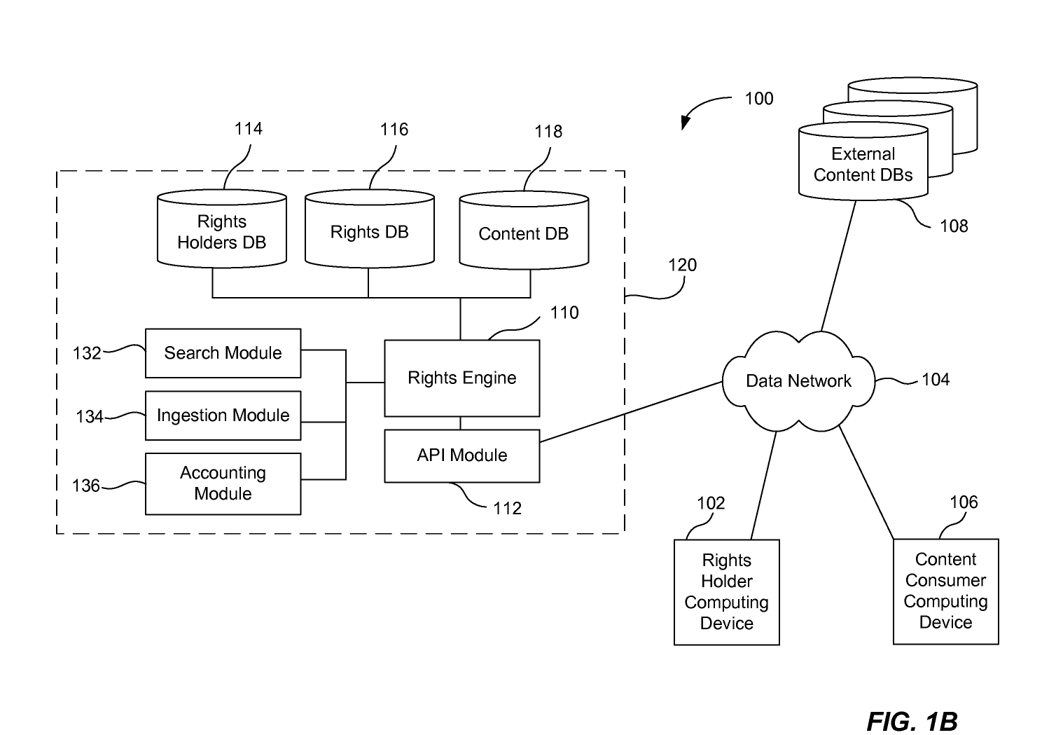

FIG. 1 depicts a component diagram of a system for submitting and retrieving content rights according to one embodiment. A rights provider 120 permits the creation of rights as well as the submission of rights to a rights engine 110. In addition, the rights provider 120 can also permit the consumption of rights associated with content items. In one embodiment, the rights provider 120 can be a business entity that has an associated computer infrastructure that permits the storing of content rights by content rights holders as well as the consumption of content rights from content consumers. As such, the rights provider 120 can provide an API module 112 to interface via a data network 104 with rights holders and content consumers. For example, a rights holder can communicate via the data network 104 utilizing a rights holder computing device 102. The rights holder computing device 102 can be configured to interact with functionality of the rights engine 110 via a set of APIs (application program interfaces) that can be invoked by the rights holder computing device 102. As such, a rights holder can utilize one or more APIs provided by the API module 112 to submit content items or location of content items as well as associated rights corresponding to the content items. In one example, the APIs provided at the API module 112 can include, for example, operations such as create, read, update and delete that can be applied to one or more content items and/or associated rights to the content items.

In one embodiment, a rights holder that submits content item information and content rights to the rights engine 110 can be a subscribed rights holder that has an associated rights holder identifier. As such, the rights holder identifier and other information related to the rights holder can be, for example, stored at a repository such as rights holder database 114. Table A shows an exemplary rights holder record with corresponding fields and a description of the fields. The rights holder record can for example include information related to the rights holder such as the name, contact information, rights holder identifier, payment information, website address, tags, associated with the content, among others.

TABLE A
Rights Holder

| Field | Description |
|---|---|
| rightsholder_name | name of rights holder |
| contact_name | contact name |
| contact_email | email address of contact |
| contact_phone | phone number of contact |
| physical_address | address_of_rightsholder |
| assigned_ID | a sixteen character ID assigned by system |
| pay_to_institution | bank or other institution name |
| routing_number | bank routing number |
| bank_account_number | bank account number |
| web_address | URL of rights holder website |
| rightsholder_tags | tags in string form, created by r.h. or others |

A rights provider 120 can further include as part of its computer infrastructure a rights database 116 and a content database 118. The rights database 116 can include one or more records indicative of rights information such as license agreements, patent documents, trademark registration, copyright registrations, etc. stored in association with content items. Furthermore, the content database 118 can store one or more content items or content items addresses as received from a rights holder who has submitted a content item. Therefore, in one example, a rights holder can for example submit simply the address or location of a content item such as a media file or a software application or a service. In another example, a rights holder can provide the actual content item and upload the content item to the content database 118. In order to do this, the rights holder would connect via the rights holder computing device 102 to the rights engine 110 utilizing one or more APIs via the API module 112. The rights holder can then, for example, submit a video clip that is uploaded to the content database 118. The rights holder's database 114, the rights database 116 and the content database 118 as well as any data repositories utilized by the rights engine 110 can be locally and directly connected for interfacing with the rights engine 110, or can also be remotely connected via a data network such as data network 104. Although the latter example is not illustrated in FIG. 1, a data network such as for example the Internet can be utilized to access remote databases via the Internet.

In a further embodiment, an external content database 108 can be accessible to the rights engine 110. Thus, for example, when a rights holder provides a location for content items, the rights engine 110 can be configured to retrieve the content item information from the external content database 108. In one example, the rights engine 110 can be configured to simply store a reference address at the content database 118 which references the content items stored in the external content database 108. In another example, the rights engine 110 can be configured to copy the content items stored in the external content database 108 into the content database 118. The system 100 can further interact with a content consumer computing device 106 that is utilized by a content consumer to access the content items as well as the rights associated with the content items. The content consumer computing device 106 can also be configured with logic to utilize the APIs provided by the rights provider 120 in order to request one or more content items according to the associated rights of the content items. Content consumers can include for example end users, individuals, large business entities such as production companies, film makers, etc. In addition, the content consumer can for example be business units associated to the rights provider 120. In yet another example, the content consumers can be partners or affiliates of the rights provider 120. As previously mentioned, content consumers can further utilize content items and associated rights to further manipulate, edit, mix or change content which is then recycled and fed again to the rights engine 110 as a new content item with new associated rights. In this manner, a content consumer becomes a rights holder.

FIG. 1B depicts a component diagram of a system for ingesting content items and rights, searching content items and rights, and accounting, according to one embodiment. In one embodiment, the API module 112 can further be coupled to one or more logic modules to perform necessary operations for the submission, retrieval and recycling of content items and associated rights. A search module 132 can be provided with logic in order to perform searches of specific content items that a content consumer may search for, as well as specific rights that a content consumer would like to license or obtain. For example, a content consumer can submit a query to the search module 132 for searching rock music from the year 2004 with public domain rights. Other examples exist of queries that can be utilized to search content items via the rights engine 110. Search parameters can for example include rights holder's names, rights holder's contact information, form of payment, licensing fee, type of content item, size of content item, quality of content item, etc.

In another embodiment, an ingestion module 134 can be configured to receive content items as well as associated rights from a rights holder through the data network 104. In one embodiment, the ingestion module 134 is configured to receive at least one content item or location of the content item and associated rights. In another embodiment, the ingestion module 134 is configured to receive a bulk feed, for example, a rights holder may have hundreds of songs that a rights holder would like to register at the rights engine 110, and assign associated rights. In order to do this, a rights holder can submit the content item information in bulk in order to facilitate the process. In one example, the rights holder may provide one indication of the type of bundle of rights that needs to be associated with the bulk of content and subsequently, the bulk of content can be uploaded, or a location where the bulk of content exists, can be provided to the rights engine 110.

An accounting module 136 can also be included as part of the rights provider 120 infrastructure. The accounting module 136 can be configured to receive payment from a content consumer and allocate the payment to the correct rights holder. To do this, the accounting module 136 can be configured to access the rights holders database 114 as well as the rights database 116 wherein license fee information associated with specific rights or a content item is stored. As such, the accounting module 136 can correlate license fees required by rights holders and ensure that payment is provided for content that has been provided at a desired cost.

While various databases have described herein, one skilled in the art will recognize that each of the aforementioned databases can be combined into one or more data repositories, and be located either locally or remotely. In addition, each of the aforementioned databases can be any type of data repository configured to store data and can be implemented using any methods of storage now known or to become known. Likewise, while various modules have described herein, one skilled in the art will recognize that each of the aforementioned modules can be combined into one or more modules, and be located either locally or remotely. Each of these modules can exist as a component of a computer program or process, or be standalone computer programs or processes recorded in a data repository.

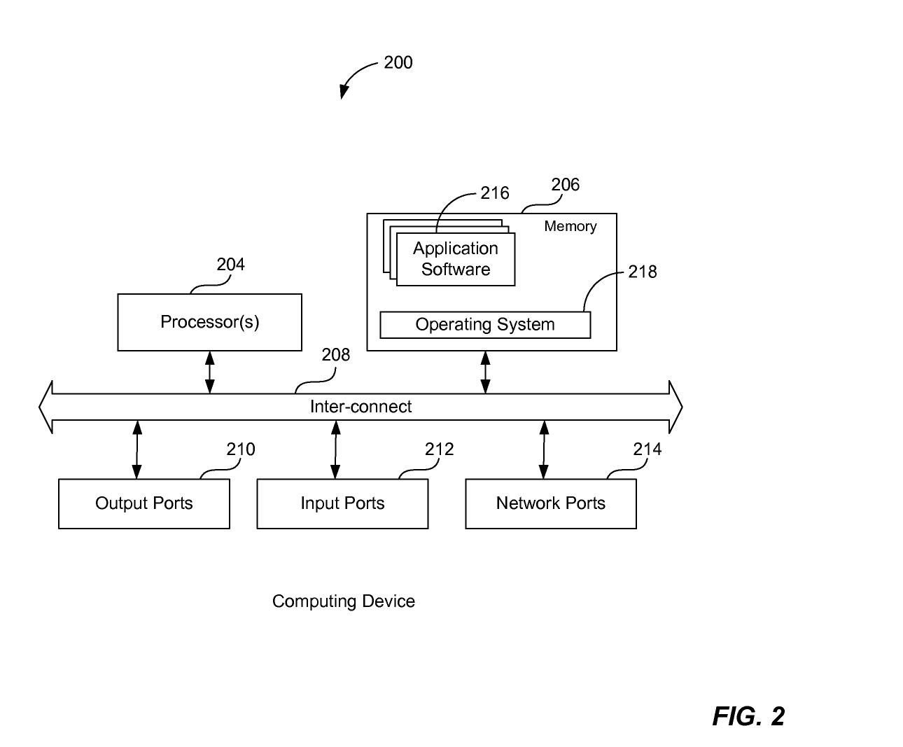

FIG. 2 depicts a component diagram of a computing device according to one embodiment. The computing device 200 can be utilized to implement one or more computing devices, computer processes, or software modules described herein. In one example, the computing device 200 can be utilized to process calculations, execute instructions, receive and transmit digital signals, as required by the computing device 200. In one example, the user computing device can be utilized to process calculations, execute instructions, receive and transmit digital signals, receive and transmit content data and associated rights, as required by the rights engine and API modules.

The computing device 200 can be any general or special purpose computer now known or to become known capable of performing the steps and/or performing the functions described herein, either in software, hardware, firmware, or a combination thereof.

In an example, computing device 200 includes an inter-connect 208 (e.g., bus and system core logic), which interconnects a microprocessor(s) 204 and memory 206. The inter-connect 208 interconnects the microprocessor(s) 204 and the memory 206 together. Furthermore, the interconnect 208 interconnects the microprocessor 204 and the memory 206 to peripheral devices such input ports 212 and output ports 210. Input ports 212 and output ports 210 can communicate with I/O devices such as mice, keyboards, modems, network interfaces, printers, scanners, video cameras and other devices. In addition, the output port 210 can further communicate with the display 104.

Furthermore, the interconnect 208 may include one or more buses connected to one another through various bridges, controllers and/or adapters. In one embodiment, input ports 212 and output ports 210 can include a USB (Universal Serial Bus) adapter for controlling USB peripherals, and/or an IEEE-1394 bus adapter for controlling IEEE-1394 peripherals. The inter-connect 208 can also include a network connection 214.

The memory 206 may include ROM (Read Only Memory), and volatile RAM (Random Access Memory) and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The memory 206 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a file structure may be stored in memory 206 or obtained through input ports 212 and output ports 210.

In general, routines executed to implement one or more embodiments may be implemented as part of an operating system 218 or firmware or hardware, or a specific application, component, program, object, module or sequence of instructions referred to as application software 216. The application software 216 typically can comprises one or more instruction sets that can be executed by the microprocessor 204 to perform operations necessary to execute elements involving the various aspects of the methods and systems as described herein. For example, the application software 216 can include video decoding, rendering and manipulation logic.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

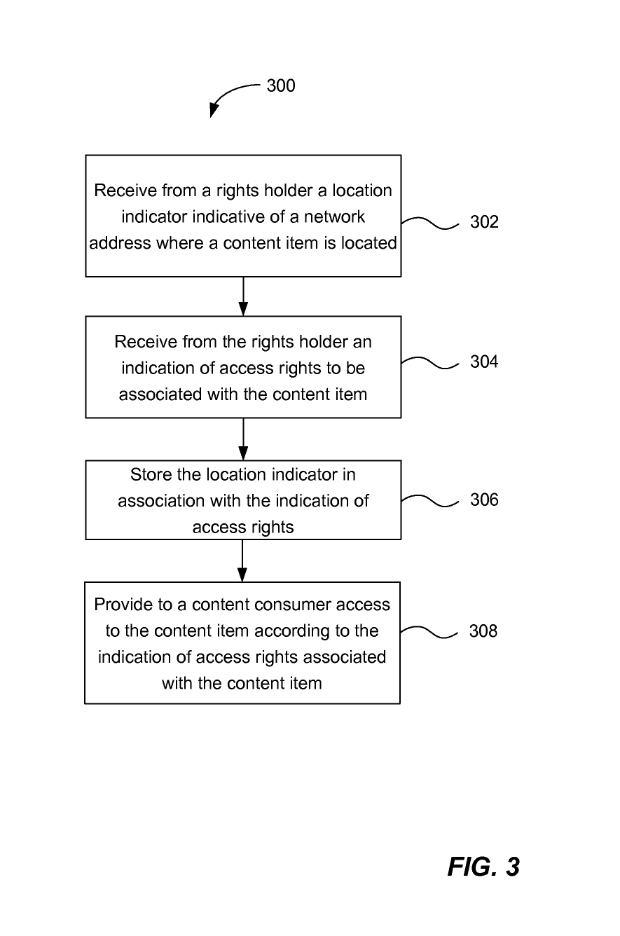

FIG. 3 depicts a flow diagram of a process for submitting content rights to a rights provider according to one embodiment. At process block 302, a location indicator that is indicative of a network address where the content item is located is received from a rights holder. In one example, the location indicator can be a URL (universal resource locator) address or URI (universal resource identifier). In another embodiment, the location indicator can be, for example, an IP (internet protocol) address. Process 300 continues at process block 304.

At process block 304, an indication of access rights to be associated with the content item is received from the rights holder. Access rights can, for example, be sharing rights, publication rights, distribution rights, indications of what territory is covered by the access right, an indication of what devices are covered by access right, etc. Process 300 continues at process block 306.

At process block 306, the location indicator is stored in association with the indication of access rights. As such, the location indicator can be stored with a reference to the access rights associated to the content item corresponding to the location indicator. Process 300 continues at process block 308.

At process block 308, content consumers are provided access to the content item according to the location indicator and the indication of access rights associated with a content item. As such, either the content item is provided to the content consumer or an address to the content item is provided to the content consumer.

### Rights and Content Submission

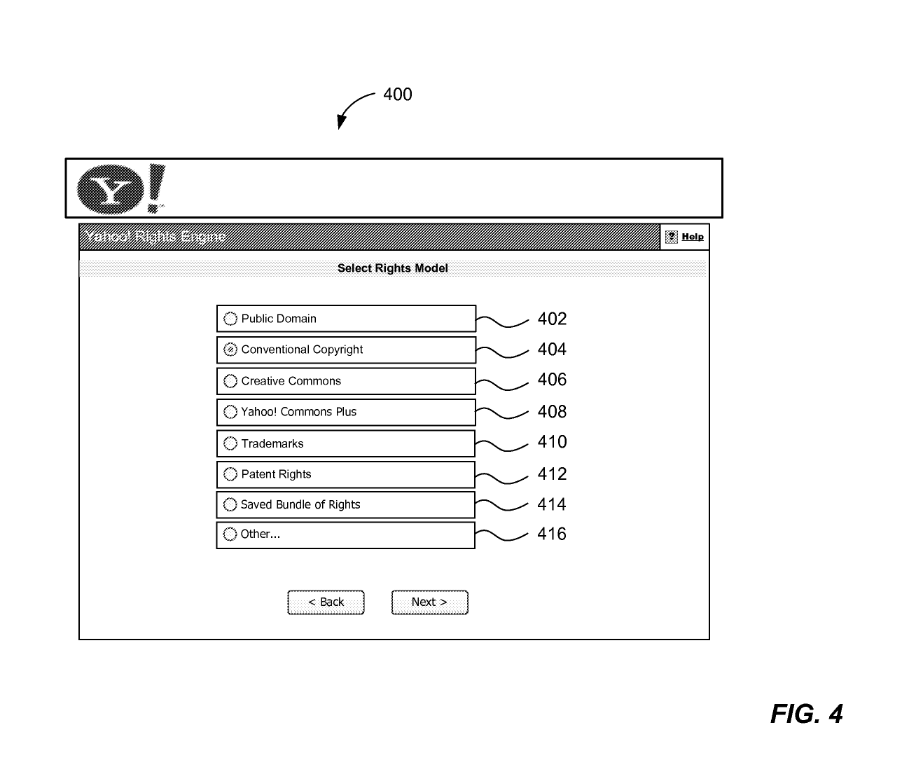

As mentioned above, one or more types of rights can be assigned to a content item to be provided to a content consumer. Thus, a rights holder can utilize one or more interfaces to enter rights and content information to the rights engine 110. The user interfaces provided in FIGS. 4 through 10 are exemplary user interfaces only. Therefore, other processes and user interfaces can be utilized by a rights holder to register and submit a content item as well as configure one more rights associated to the content item. For example, a rights holder can submit a source code script that includes calls to one or more APIs.

Furthermore, rights holders can be users that are subscribed to their rights provider 120 and have a user identifier. In another embodiment, a rights holder can be anonymous users.

FIG. 4 depicts an example of a user interface for providing a rights model selection to a rights holder according to one embodiment. Interface 400 provides a list of rights models that can be selected by a rights holder. The rights model selected by the rights holder can be supplied in relation to the content item. Thus, for example, if the content item is a trademark, the rights model utilized as applied to the trademark can include a determination of a geographical location or area where the license is provided, fields for quality control, etc. In another example, if the content item is a digital video clip, the rights holder may want to utilize a public domain rights model or a conventional copyright rights model. As one skilled in the art will appreciate, the rights model selected by the rights holder can vary according to the content item and/or can be applied freely by the rights holder.

In one example, a public domain selection 402 can be provided to a rights holder. The public domain selection 402 can permit a rights holder to indicate the parameters and conditions under which a specific content item is provided as part of a public domain. For example, the rights holder may require that recognition of the rights holder and creator's name be included as part of the display, distribution or performance of a specific media item. As such, if a rights holder selects the public domain selection 402, further user interface screens may be presented to the rights holder in order to enter information related to public domain rights associated with the submitted content item. The public domain information related to the content item can be stored as a record in the rights database 116. Table B depicts an exemplary data structure corresponding to a record for a public domain rights entry. Information related to the content item such as name, author, description, type and format can be stored as part of the public domain entry. In addition, the location of the associated content item can be stored in the form of a URL, URI, or any other address of reference. Finally, tags can also be entered as part of the public domain entry in order to make the content item related to the public domain entry searchable.

TABLE B
Public Domain

| Field | Description |
|---|---|
| item_name | name, a string |
| item_author | name, a string |
| item_description | description, 256 characters |
| item_type | video\|audio\|image\|text\|interactive |
| item_format | mpeg-1\|mpeg-2\|jpeg\|gif\|quicktime\|text\|etc. |
| item_assigned_ID | system-assigned unique ID |
| rightsholder | system-assigned unique ID |
| item_location | URL of item |
| item_group | name of semantic grouping item belongs to |
| rightsholder_tags | tags in string form, created by r.h. or others |

In another example, a conventional copyright selection 404 can be provided as part of user interface 400 to a rights holder. A rights holder may select a conventional copyright selection 404 if the rights holder wants to register or submit a content item and in addition, provide a traditional copyright right associated to the content item. An associated rights entry can be stored in the rights database 116 according to one or more configurations. In one embodiment, one configuration can include the content item information such as name, author, description, type and format of the content item. In addition, information related to the type of agreement required, such as distribution and user wholesale, etc. can also be provided as one of the fields in the configuration data structure. Furthermore, the location of signed agreements and agreement documents related to the conventional copyright can also be included as part of the rights entry recorded and stored at the rights database 116. Information related to the period of the license, as well as fee related information such as amounts, currency, percentage of retail sales, etc. can be also part of the rights entry for a conventional copyright. Other information such as the territory where a license can be provided, devices that may be permitted to render the content item and any other information that can be used to limit or extend the associated rights. Table C below is an exemplary table that illustrates a data structure corresponding to an entry for a conventional copyright.

TABLE C
Conventional Copyright

| Field | Description |
|---|---|
| item_name | name, a string |
| item_author | name, a string |
| item_description | description, 256 characters |
| item_type | video\|audio\|image\|text\|interactive |
| item_format | mpeg-1\|mpeg-2\|jpeg\|gif\|quicktime\|text\|etc. |
| rightsholder | system-assigned unique ID |
| agreement_type | distribution, end-user, affiliate, wholesaler, |
| | other |
| signed_agreement | URL of scanned agreement |
| final_agreement_unsigned | URL of word proc document |
| item_location | URL of item |
| item_group | name of semantic grouping item belongs to |
| license_start | a time |
| license_end | a time |
| fee_required? | yes or no |
| paid_by | end user\|distributor, other |
| fee-type | flat fee\|percentage\|pay-per-view\|subscription |
| percentage_of_retail | a percentage |
| flat_fee_amount | amount |
| currency | form of currency (e.g., USD, GBP, etc.) |
| territory | global\|list of territories |
| device | global\|list of devices |
| drm | none\|form of DRM |
| copyright_year | year of copyright created |
| item_tags | tags in string form, created by r.h. or others |

A third party rights management scheme, such as for example creative commons selection 406 can also be included as part of the rights model list. For example, the creative commons selection 406 can be utilized by a rights holder who wants to provide access to his or her content items based on a creative commons scheme. As such, when the rights holder selects the creative commons selection 406, multiple user interfaces can be provided such that the rights holder can input the location of the content item as well as creative commons references as related to the content item. Table D below exemplifies a data structure for a creative commons entry that can be stored in the rights database 116. The creative commons entry can include item information such as name, author, subscription, type and format. In addition, creative commons information specific to the content item can also be included, such as the agreement type, etc. The jurisdiction (generic or specific), modifications (true, false, share alike), and commercial use (true, false). Furthermore, the content item location can also be provided and included in the creative commons entry in the form of a URL or any other location indicator.

TABLE D
Creative commons

| Field | Description |
|---|---|
| item_name | name, a string |
| item_author | name, a string |
| item_description | description, 256 characters |
| item_type | video\|audio\|image\|text\|interactive |
| item_format | mpeg-1\|mpeg-2\|jpeg\|gif\|quicktime\|text\|etc. |
| rightsholder | system-assigned unique ID |
| agreement_type | CC\|Sampling\|Sampling+\|Non-comm Smpl+ |
| allow_commercial | true\|false |
| allow_modifications | true\|false\|share-alike |
| cc_jurisdiction | generic\|specific jurisdiction |
| item_location | URL of item |
| item_group | name of semantic grouping item belongs to |
| item_tags | tags in string form, created by r.h. or others |

In another example, an alternate rights management scheme, such as for example that referred to by the assignee of this application as Yahoo! Commons Plus, as selection 408 can be provided to the rights holder to select a commons plus scheme wherein content items can be licensed exclusively or non-exclusively by payment of a fee. Thus, for example, the Yahoo! Commons Plus data structure for an entry in the rights database 116 can include item information as well as creative commons information and preferences from the rights holder. In addition, the Yahoo! Commons Plus entry can also include payment information, restrictions on duration, geographical scope, devices that can render the content item, etc. Table E below shows an exemplary data structure for a Yahoo! Commons Plus entry.

TABLE E
Y! Commons Plus

| Field | Description |
|---|---|
| item_name | name, a string |
| item_author | name, a string |
| item_description | description, 256 characters |
| item_type | video\|audio\|image\|text\|interactive |
| item_format | mpeg-1\|mpeg-2\|jpeg\|gif\|quicktime\|text etc. |
| rightsholder | system-assigned unique ID |
| agreement_type | Sampling\|Sampling+\|Non-comm Smpl+ |
| allow_commercial | true\|false |
| allow_modifications | true\|false\|share-alike |
| item_location | URL of item |
| item_group | name of semantic grouping item belongs to |
| license_start | a time |
| license_end | a time |
| fee_required? | yes\|no |
| paid_by | end user\|distributor, other |
| fee-type | flat fee\|percentage\|pay-per-view\|subscription |
| percentage_of_retail | a percentage |
| flat_fee_amount | amount |
| currency | form of currency (e.g., USD, GBP, etc.) |
| territory | global\|list of territories |
| device | global\|list of devices |
| item_tags | tags in string form, created by r.h. or others |

In yet another example, a trademark selection 410 can be provided for a rights holder to select a specific rights model. In addition, a patent rights selection 412 can also be provided for a rights holder to select the appropriate rights model.

In one embodiment, rights granted by the rights holder can be contained as part of a bundle of rights. As such a rights holder can create one or more rights bundles and apply such rights bundles to content items. A bundle of rights can be generally a configuration of rights that establishes permissions, restrictions and obligations of a content consumer with respect to a content item. Pre-configured and saved bundles of rights can be stored in association with a rights holder. Accordingly, the rights holder can apply pre-saved bundles of rights to one or more content items.

As such, the rights holder can also be provided with a saved bundle of rights selection 414. The saved bundle of rights selection permits a rights holder to go back to a specific pre-selected and pre-configured bundle of rights that the rights holder had entered in the past. For example, the rights holder may have entered a rights model for a specific content item and further selected to save the configuration of rights in relation to that content item. Such configuration of rights can be applied at a later time, as a bundle of rights, to other content items that the rights holder may want to upload. Such pre-saved bundle of rights can be useful in cases where the rights holder continuously submits content items and content item information that the rights holder would like to have similar rights applied to.

In one example, the public domain rights model can be configured by a rights holder with modified rights that can be saved as a new bundle of rights. In another example, the conventional copyright rights model can be configured by a rights holder with modified rights that can be saved as a new bundle of rights. In another example, the creative commons rights model can be configured by a rights holder with modified rights that can be saved as a new bundle of rights. In another example, the trademark rights model can be configured by a rights holder with modified rights that can be saved as a new bundle of rights. In another example, the patent rights model can be configured by a rights holder with modified rights that can be saved as a new bundle of rights.

In yet another example, the previously saved bundle of rights can also be configured by the rights holder with modified rights that can be saved as a new bundle of rights. As such, the saved bundle of rights selection 414 can be configured with new terms, obligations, restrictions so as to change the saved bundle of rights, and effectively create a new configuration of rights that can be saved as a new bundle of rights.

In addition, a customized configuration of rights can also be created and later saved as a bundle of rights. In one embodiment, a selection 416 can be provided for a rights holder to select a customized selection of rights that allows a rights holder to establish territorial scope, fee payments, rendering devices scope, exclusivity, etc. In addition, any other types of rights definitions can be associated with the customized configuration of rights. In other words, a rights model can be configured with a new set of restrictions, permission, and obligations that are created by the rights holder and that are not necessarily a conventional granting of rights. For example, a rights holder may create a bundle of rights that provides public domain rights to a song, under the condition that every time the song is performed in public, the name of the band is announced at the beginning and at the end of the song. One of ordinary skill in the art will recognize, from the teachings herein, that there are various ways of configuring a rights model and that the examples provided herein are for illustration purposes only.

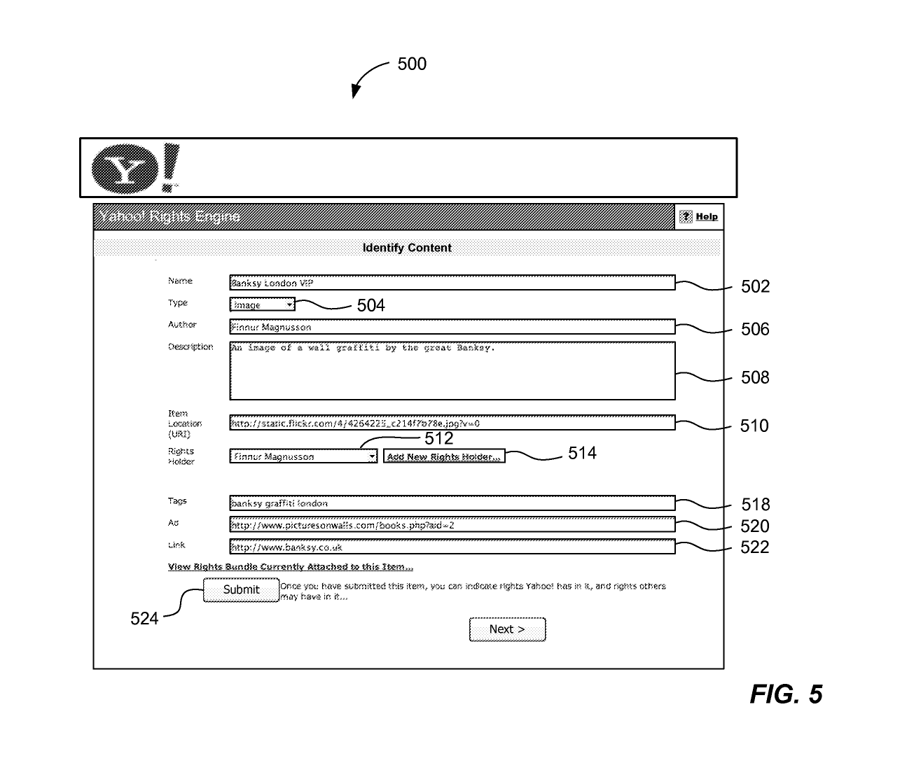

FIG. 5 depicts an example of a user interface for identifying a content item according to one embodiment. The rights holder can enter the information related to a content item in various text fields of user interface 500. A text field 502 can be included to permit the rights holder, or any other entity entering the content item information, to enter a name of the content item. A user interface 504 can be included to permit the rights holder to enter the type of the file corresponding to the content item. In another embodiment, the type of the file corresponding to the content item is programmatically determined by the rights engine 110. As such, the rights engine 110 can be configured to scan the content item and establish the data type or content of the content item.

A text field 506 can be included to permit the rights holder to enter the name of the author, inventor or creator of the content item. A text field 508 can be included to permit the rights holder to enter a description of the content item. The description can later be displayed for content consumers.

In one embodiment, the rights holder can enter a location where multiple content items are located. For instance, the rights holder can enter the network location or URI in field 510. In another embodiment, the rights holder may select to enter one specific content item that is located in a network location. For example, the rights holder may enter, at field 510, a network address or location indicator of a specific file. Furthermore, the rights holder may choose to upload the content items to the content database 118 or to simply upload a link to the content items.

A dropdown menu 512 can be included to permit the rights holder to select the name of the rights holder from a list of previously subscribe rights holders. If the rights holder is not yet subscribed a registered rights holder, the rights holder can choose to create an account using button 514.

Various other text fields 518, 520 and 522 can be included to permit the rights holder to enter additional information regarding the content item. Such information can include additional tags, advertisement locations, links, etc.

In one example, a button 524 can be utilized to submit the digital files corresponding to the content items. In another example, the rights holder can select button 524 to simply upload the reference address of the content items.

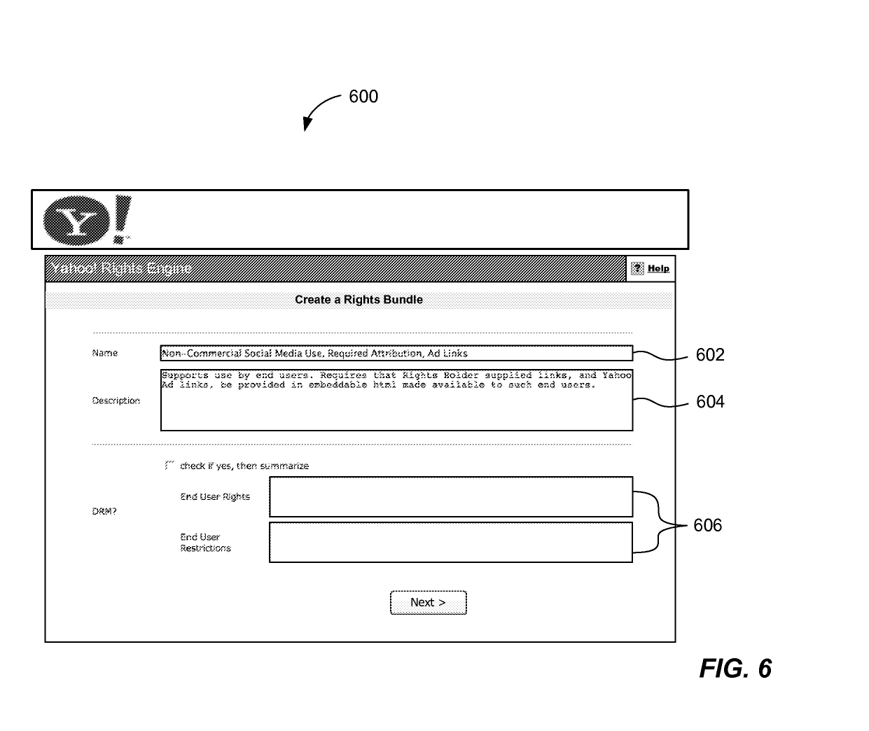

FIG. 6 depicts an example of a user interface for creating a rights bundle according to one embodiment. In one embodiment, user interface 600 can include various user interface mechanisms to permit a rights holder to enter rights bundle information. For example, a name field 602 can be part of the user interface 600 to allow a rights holder to enter a name of a created rights bundle. Also, a description field 604 can be also included as part of the user interface 600 in order to allow the rights holder to enter description information. Furthermore, various fields 606 can be part of the user interface 600 to enter digital rights management information. For example, end user rights and user restrictions can be entered in association with digital rights management schemas.

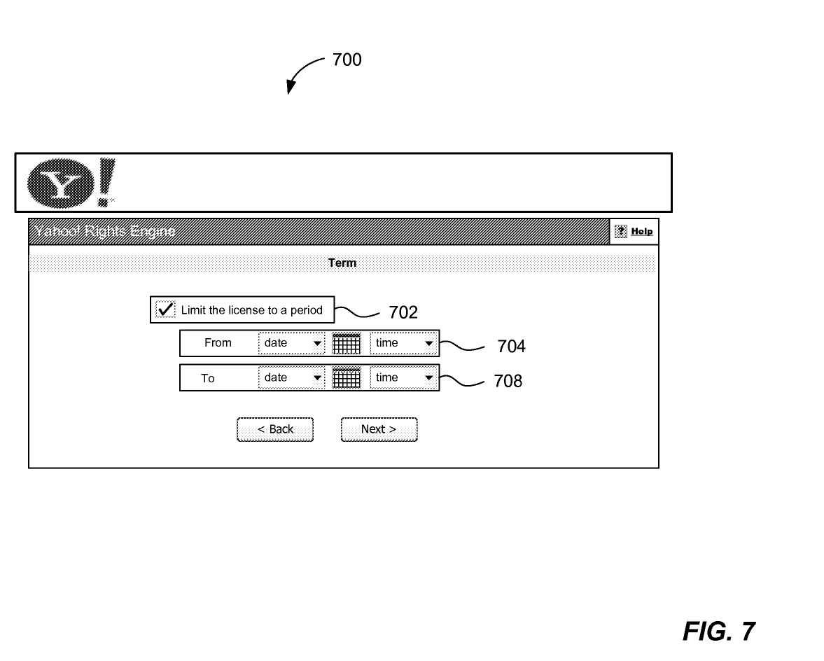

FIG. 7 depicts an example of a user interface for entering a term of a rights bundle according to one embodiment. The user interface 700 can be provided for a rights holder who wishes to limit the distribution of a content item based on a license that lasts a specific time period. As such, the rights holder may utilize checkbox 702 to indicate that a rights holder wants to limit the license for a specific period of time. For example, user interface 704 includes a check box, a date field and time drop-down menus that will permit a rights holder to indicate a time and a date in which the license period will start. In addition, a user interface 708 can include a checkbox to indicate that there is an ending period as well as a text box for entering the date and drop down menus for entering a time. As can be appreciated by one skilled in the art, a rights holder may choose not to limit a license to a specific period. In another example, the rights holder may choose to limit the license to a specific period of time that starts at a selected date and time and ends at a selected date and time. In another example, the rights holder may select to start a license at a selected time and date, and may further choose not to have an ending date for the license period. In another example, the rights holder may simply choose an ending date, in which case the starting date would be the date in which the rights holder completes the submission of the content item and rights.

In one embodiment, the expiration of the rights provided to the consumer can be enforced using one or more known methodologies. For example, the content item can be accompanied by an encrypted key that ceases to grant access to the content item on pre-determined date. For example, a rendering device would only render the content item according to the provided key associated with the content item. In other embodiments, any digital rights management methodology can be utilized for content items. In yet another embodiment, a notice or message provided to the content consumer can serve as the enforcement mechanism. In yet another embodiment, content items such as intellectual property rights can have associated legal rights that are enforced as using regular vehicles for enforcing intellectual property rights (e.g. courts of law, etc).

Furthermore, in another embodiment, rights granted to content consumers are provided such that the content consumers have an incentive to maintain the integrity of the granted rights and the associated content. One skilled in the art will recognize that various mechanisms of rights delivery can be utilized.

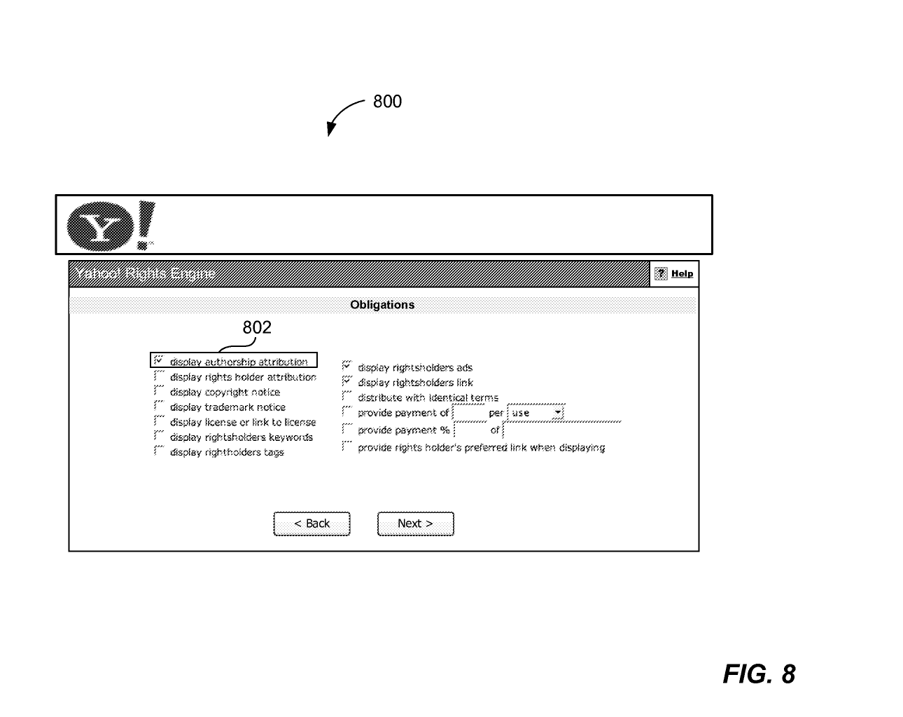

FIG. 8 depicts an example of a user interface for entering obligations related to a rights bundle according to one embodiment. For example, user interface 800 can include a list of items that can be checked by the rights holder at the time of creating or editing a rights bundle. Such list of items can refer to various obligations that can be associated with a rights bundle. As illustrated in user interface 800, a checkbox 802 can be associated with the option of requiring a content user to display authorship attribution. Thus, for example, if a content consumer has acquired or purchased the right to use a specific content item and the content item has a bundle of rights associated therewith, then the obligations created as part of the rights bundle are binding obligations that the content consumer must abide by. Other examples of obligations can include the obligation to display rights holder attribution, copyright notices, trademark notices, licenses or links to licenses, rights holder's key words, rights holder's tags, rights holder's ads, rights holder's links, and the like. Another obligation can, for example, be distributing the content item with identical terms to third party users as those terms delineated by the rights bundle. Other obligations as part of the obligations of the user interface 800 can include the obligation to make a payment for use of the content item or for a percentage based on a specific period or a pre-specified content item.

Thus a rights holder can require a flat fee or a pay-per-use scheme. Of course, a flat fee would allow a consumer to pay a one-time fee and enjoy the content item and utilize a content item as many times as the consumer would like to. A pay-per-use scheme would require that the consumer make a payment every time a consumer used the content item.

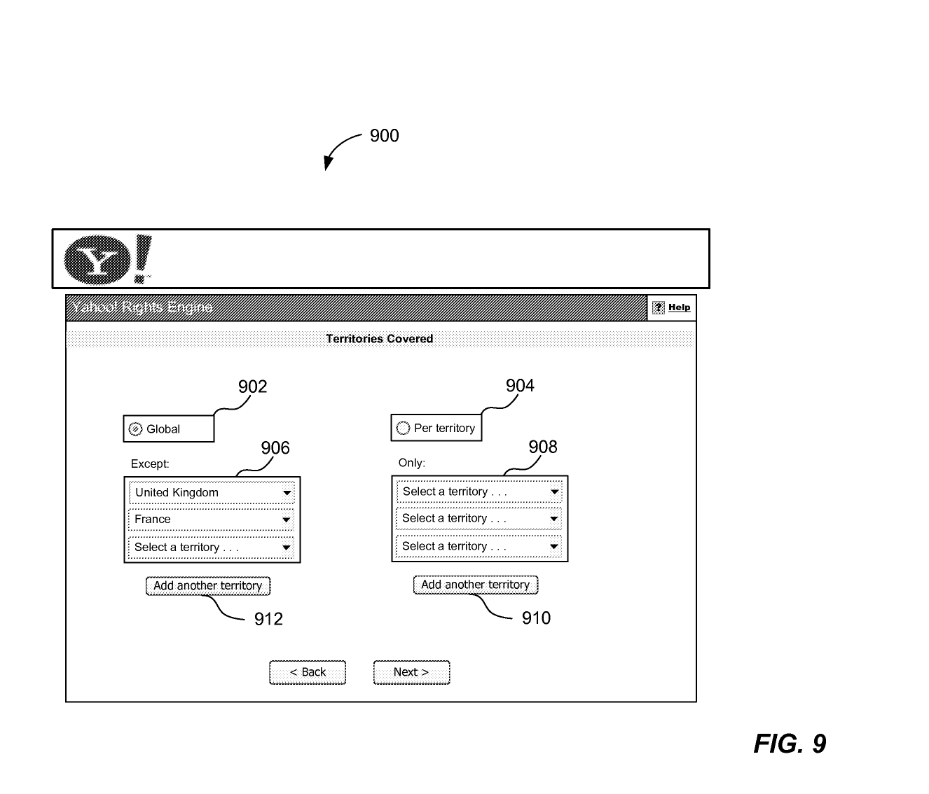

FIG. 9 depicts an example of a user interface for entering permitted territories information related to a rights bundle according to one embodiment. At user interface 900, the rights holder can select whether the distribution of rights or the rights that are being granted for a specific content item or bulk of content items is to be global or very specific territory. In other words, a rights holder can specify the geographical scope of coverage that is provided with the granting of a right or rights associated with the content item. In one embodiment, the rights holder is provided with a radio button 902 and a radio button 904 in order to make a selection of whether the rights are to be made global or per territory. If the rights holder selects radio button 902, the rights are generally assigned globally and further, if the rights holder wants to exclude certain territories, the rights holder can select one or more drop-down menus 906. For example, the rights holder may select to extend specific rights globally except for the United Kingdom and France. In addition, if further territories are to be added, the user interface 900 can provide a button 912 that allows adding additional drop-down menu items 906 so as to enter additional territories that are to be accepted from a global coverage of the license. Furthermore, in another embodiment, the rights holder may select radio button 904 to select specific territories of coverage of the associated rights. Therefore, once the rights holder has selected the radio button 904, additional drop-down menus 908 can be provided for the rights holder to select the territories in which the granted associated rights will be effective. Only in the associated countries or territories provided in drop-down menu 908 will the rights granted be legally utilized. If a rights holder wants to add additional territories to the list of drop-down menus 908, the rights holder may select button 910 to add further drop-down menu boxes to allow the rights holder to select additional territories.

Again territorial limitations can be enforced using various known technologies. In one example, if the IP address of the content consumer is indicative of a corresponding territory that is unauthorized, the content consumer will not be able to receive the content item. Other mechanisms are contemplated for enforcing rights provided to a content consumer. In another embodiment, granted rights do not have to be enforced, and instead, the content consumer can be provided with incentive to maintain the integrity of the granted rights and associated content.

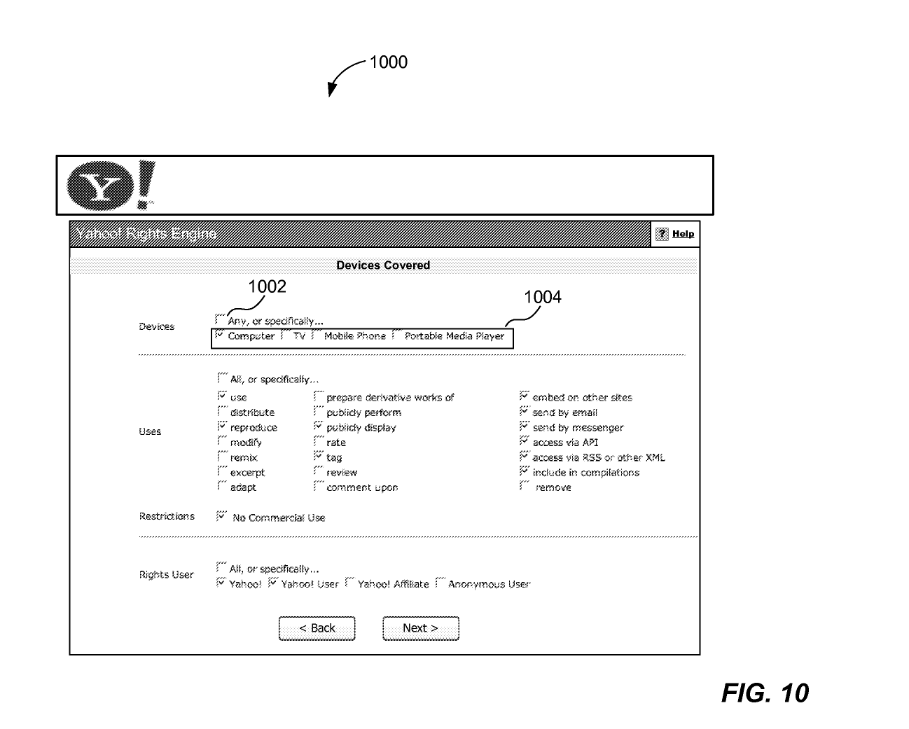

FIG. 10 depicts an example of a user interface for entering permitted devices, uses and restriction information related to a rights bundle according to one embodiment. The rights holder can select one or more devices that can be utilized by a content consumer to render specific content. The rights holder can, for example, select that all devices are covered and can be legally utilized to render the content items if the rights holder selects the checkbox 1002. Furthermore, the rights holder can decide to select a specific device type by selecting one or more checkboxes 1004. The checkboxes can allow a rights holder to specify which devices are allowed or permitted to render the content items. For example, a computer checkbox, a TV checkbox, a mobile phone checkbox and a portable media player checkbox can be included for selection of the rights holder. Such selection would be indicative of devices can render the content item. Of course, additional devices can also be included to be rendering devices of the content item by adding additional checkboxes. As such, if the rights holder wants to exclude one or more devices from rendering the content item, the rights holder would simply not select the checkboxes related to the devices that can render the content item. As it will be understood by one skilled in the art, this configuration of specifying which devices are permitted to play back the content item and which devices are not permitted to play back the content items can be recommended in other ways.

Furthermore, the rights holder may select one or more checkboxes 1006 to specify the type of uses that are permitted for the specific content item. Thus, for example a rights holder can configure the rights bundle to permit specific uses such as distribution or reproduction of the content item but prevent modification or remixing of a content item. Therefore, the rights holder can select that permissible use of the content item can be to distribute, reproduce or modify, remix, excerpt, adapt, prepare derivative works, publicly perform, publicly display, rate, tag, review, comment upon, embed on other sites, send by e-mail, send by messenger, access via API, access via RSS or other XML, include in compilations, remove, etc. As shown in user interface 100, checkboxes 1006 can be selected or deselected by the rights holder to enable or prevent the aforementioned uses.

In another embodiment, a checkbox 1008 for no commercial use can also be included in user interface 1000. The checkbox for no commercial use would be selected by a rights holder who wants to prevent the content item from being used commercially. In addition, a text field 1010 for a permitted domain can also be included to allow the rights holder one or more domain names that are permitted to receive, render or download the content item. For example, if a content consumer is located or affiliated with a domain that is not permitted or listed in the text field 1010, the content item would not be provided to the content consumer.

In addition, the type of content consumer can also be restricted by checking whether or not the content consumer is affiliated to the rights provider 120. Thus, for example, if the rights provider 120 is Yahoo!, the user interface 1000 can include one or more checkboxes 1012 that would permit a rights holder to select whether Yahoo! users, Yahoo! affiliates or other users are allowed to view, render, or in general use the content item.

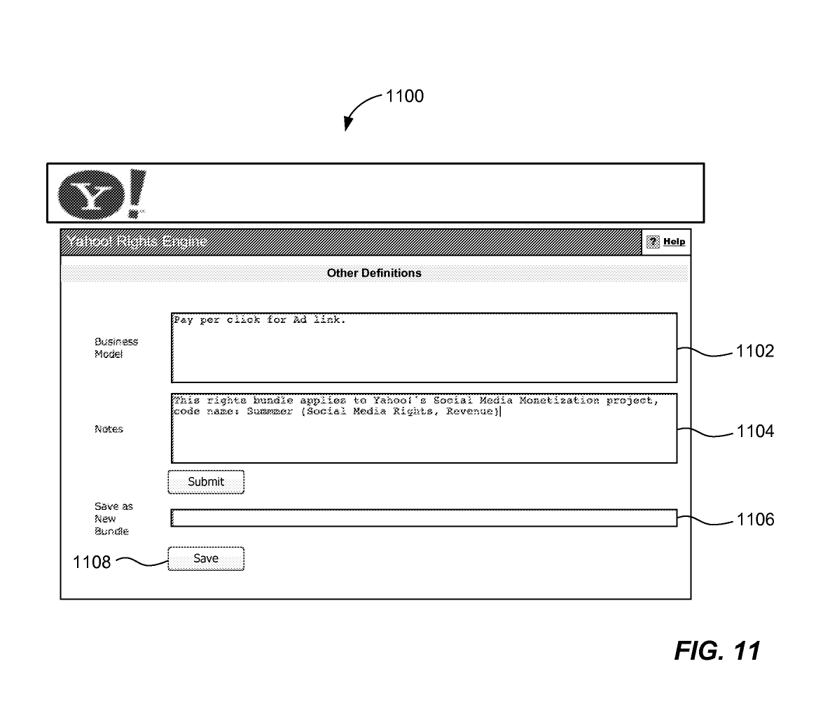

FIG. 11 depicts an example of a user interface for selecting additional definitions for a rights bundle according to one embodiment. A textbox 1012 for specifying the business model can be included as part of user interface 100. For example, the business model can be a pay-per-click model for an ad link model. Additional notes can be included in a text field 1104.

In a further embodiment, the user interface 1100 can be selected by the rights holder to indicate whether or not the rights configuration for the rights bundle should be saved for later use. A save button 1108 can be provided to the rights holder in order to permit the rights holder to select that the rights configuration be saved as a new bundle of rights. As previously mentioned, the bundle of rights includes definitions that delineate coverage of territories, devices, fee information, term of the rights, uses, restrictions and any other definitions associated with such bundle of rights. As such, once the rights holder saves the bundle of rights, the saved bundle of rights can be accessible to the rights holder so that the rights holder can apply the saved bundle of rights to other or new content items.

### Rights and Content Access

Once the rights holder has provided content data and rights preferences to the rights provider 120, the content item and associated rights can be made available to content consumers. Thus, content consumers can utilize a client application residing on the content consumer computing device 106 in order to search content items and associated rights. Search results can be provided to the content consumer in various formats.

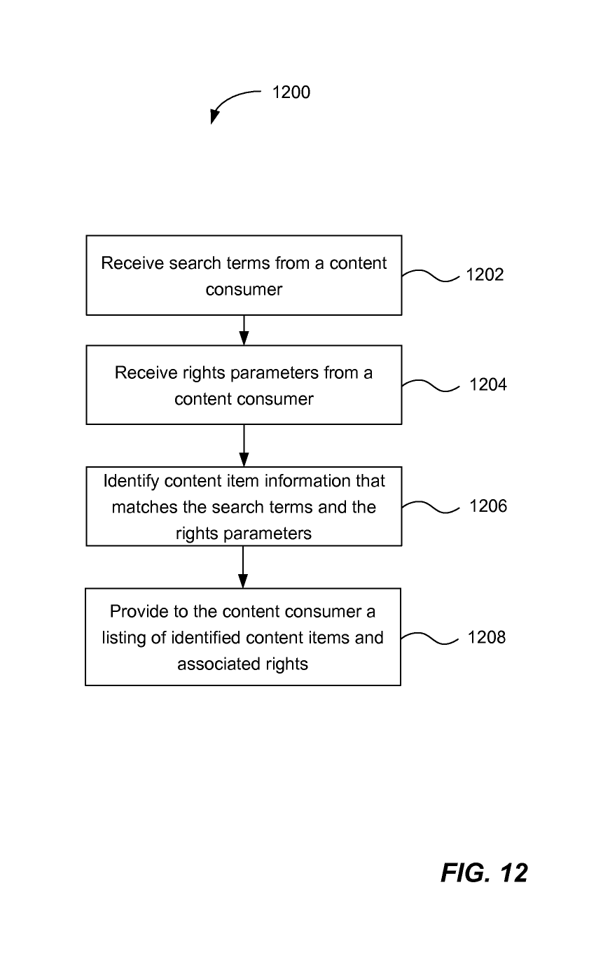

FIG. 12 depicts a flow diagram of an example of a process for searching content items and associated rights according to one embodiment. At process block 1202, search terms are received from a content consumer. Search terms can relate for example to the name of the rights holder, the title of a specific content item the content consumer is looking for, a specific categorization or genre of the content item, etc. The process 1200 continues to process block 1204.

At process block 1204, rights parameters are received from a content consumer. Thus, the content consumer can select the types of rights that the content consumer would like to obtain. Parameters received from the content consumer can include fee information, time limitations, and geographical scope, among others. In one embodiment, a search text box can be provided as part of a user interface. In another embodiment, specialized drop-down menus, radio buttons, etc., can be provided for the content consumer to specific rights parameters desired by the content consumer. The process 1200 continues to process block 1206. In another example, the parameters received can be in the form of an API call.

At process block 1206, content item information that matches the search terms and the rights parameters is identified. As previously discussed, the search module 132 can be configured to cooperate with a rights engine to search for relevant content and rights. The process 1200 continues to process block 1208. At process block 1208, a listing of identified content items and associated rights can be provided to the content consumer. The listing can be in one or more formats. In one embodiment, the listing can be an HTML file that is rendered as a list of content item names and corresponding associated rights. In another embodiment, the listing can be an XML (extensible markup language) file that is fed to a client application in the content consumer 106 device and displayed to the content consumer. Table F below illustrates an XML result file for a search for French rap. Table F shows a source code example of generated XML source code that lists the rights holder information.

```
TABLE F
<?xml version=”1.0”?>
<?xml-stylesheet href=”catalog.xsl” type=”text/xsl”?>
<!DOCTYPE rightsholders SYSTEM “rightsholders.dtd”>
<rightsholders>
    <rightsholder>
      <rightsholder_name>Kaemeleon, lnc.</rightsholder_name>
      <contact_name>John Smith</contact_name>
      <contact_email>jsmith@kameleoninc.com</contact_email>
      <contact_phone>4155551212</contact_phone>
      <physical_address>123 Main Street, San Francisco, CA 94123</
      physical_address>
      <assigned_ID>Y191953</assigned_ID>
      <pay_to_institution>Wells Fargo</pay_to_institution>
      <routing_number>368127849</routing_number>
      <bank_account_number>49820398008</bank_account_number>
      <web_address>www.kameleoninc.com</web_address>
      <rightsholder_tags>new, paris, underground, summer</
      rightsholder_tags>
    </rightsholder>
    <rightsholder>
      <rightsholder_name>Orbitron, Unlimited</rightsholder_name>
      <contact_name>George Melchior</contact_name>
      <contact_email>george@orbitronul.com</contact_email>
      <contact_phone>2125552344</contact_phone>
      <physical_address>55 Pine Street, New York, NY 10012</
      physical_address>
      <assigned_ID>Y482947</assigned_ID>
      <pay_to_institution>Chase Manhattan Bank</
      pay_to_institution>
      <routing_number>458127849</routing_number>
      <bank_account_number>79389398008</bank_account_number>
      <web_address>www.orbitroninc.com</web_address>
      <rightsholder_tags>knitting, factory, keren, ann, ntm</
      rightsholder_tags>
    </rightsholder>
<rightsholders>
```

In addition, Table G below shows a source code example of generated XML source code that lists the content item information.

TABLE G

```
<?xml version=”1.0”?>
<?xml-stylesheet href=”catalog.xsl” type=”text/xsl”?>
<!DOCTYPE items SYSTEM “items.dtd”>
<items>
    <item>
      <item_name>Royale Deluxe A Cappella</item_name>
      <item_author>Le Mec</item_author>
      <item_description>Paris underground rap from the
      originals.</item_description>
      <item_type>audio</item_type>
      <item_format>256kbps MP3</item_format>
    <item_location>http://kameleoninc.com/royale/
    royal_deluxe_a_cappella.mp3</item_location>
      <item_ID>Y5552323</item_ID>
      <rightsholder>Y191953</rightsholder>
      <fee_required?>yes</fee_required?>
      <fee_type>flat fee</fee>
      <flat_fee_amount>0.50</flat_fee_amount>
      <currency>USD</currency>
      <territory>global</territory>
      <item_tags>a cappella, paris</item_tags>
    </item>
    <item>
      <item_name>Guerilla Backing Track</item_name>
      <item_author>MC Solaar</item_author>
      <item_description>International beats, recorded in
      Russia.</item_description>
      <item_type>audio</item_type>
      <item_format>256kbps MP3</item_format>
    <item_location>http://orbitronul.com/mcsolaar/
    guerillaback.mp3</item_location>
      <item_ID>Y1152343</item_ID>
      <rightsholder>Y482947</rightsholder>
      <fee_required?>yes</fee_required?>
      <fee_type>flat fee</fee>
      <flat_fee_amount>0.50</flat_fee_amount>
      <currency>EUR</currency>
      <territory>global</territory>
      <item_tags>a cappella, paris</iitem_tags>
    </item>
</items>
```

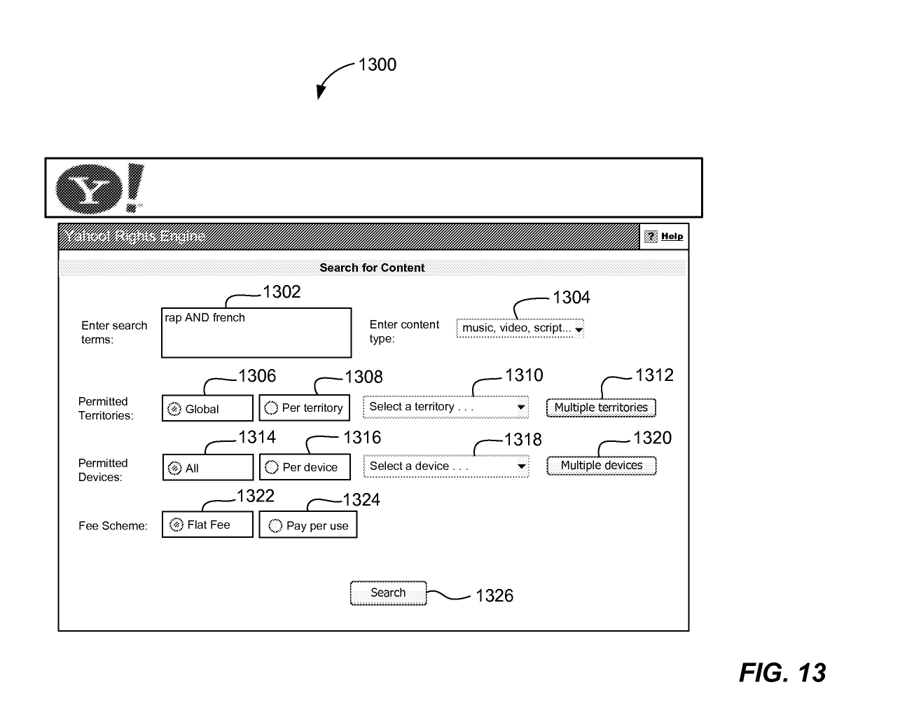

FIG. 13 depicts an example of a user interface for searching content items and associated rights according to one embodiment. User interface 1300 can permit a content consumer to enter one or more search criteria in order to search for content and associated rights. For example a content consumer can be provided with a search textbox 1302 to enter one or more search terms. The search terms entered by the content consumer can then be utilized to perform the search for specific content items. For example, the content consumer can enter the terms “rap” and “French” and the search module 132 can identify in the content database 118 content items that have associated metadata that include the term “rap” and “French.”

The user interface 1300 can further provide a dropdown menu 1304 that permits the content consumer to enter a content type that the content consumer would like to receive as part of the search results. For example, content type can be music files (e.g. *.mp3, *.mid, *.wav, etc), video files (e.g. *.mpg4, *.avi), images (*.jpg, *.bmp), text documents (e.g., *.doc, *.pdf), scripts, narratives, literary works, software, etc. In another example, the content type can be a patent. In another example the content type can be a trademark.

A radio button 1306 and a radio button 1308 can be provided as part of a user interface 1300 to permit a content consumer to select a global rights license or a per-territory rights license. Thus, for example if the content consumer selects the radio button 1306, the content consumer would be effectively searching for content items that have associated rights that as provided by the rights holder would be global. In another example, if the content consumer selects that radio button 1308 the content consumer would be searching for content items that have associated rights that are granted on a per-territory basis or at least in the territory indicated in the dropdown menu 1310. For example, if the content consumer would like to make sure that the rights granted are in the United Kingdom, the content consumer can select that radio button 1308 and furthermore select a territory 1310 as the United Kingdom. Additionally, if the content consumer would like to select additional territories, the content consumer can select the button 1312.

In another embodiment, the user interface 1300 further provides radio button 1314 and radio button 1316 to select one or more rendering device permitted to render the content items. Thus, for example, if the content consumer selects radio button 1314 the content consumer would be searching for content items that have associated rights that permit the content consumer to utilize all of the devices available to render that content item. In another example, if the content consumer selects the radio button 1316 the content consumer would be selecting to search content items that can be at least played in the device selected in the drop down menu 1318. If the content consumer wants to select additional device, the content consumer can select button 1320 which can then present to the content consumer additional devices for selection.

User interface 1300 can further provide a radio button 1322 and radio button 1324 in order to permit the content consumer to select the fee scheme that the content consumer prefers and is searching for. As such, if the content consumer selects the flat fee ratio button 1322, only content items that are provided on a flat fee basis would be part of the search results. On the other hand, if the content consumer selects the pay-per-use radio button 1324 those content items having a pay-per-use basis scheme would be listed as part of the search results. Finally, a search button 1326 can be provided to the content consumer in order to submit a search.

In further embodiment, the content consumer can submit a search through a client application that receives user interface input from the content consumer, and generates a source code file that invokes API calls to be received and interpreted by the API module 112. For example, the generated code file can be an XML file that can be parsed and interpreted by the API module as a search request.

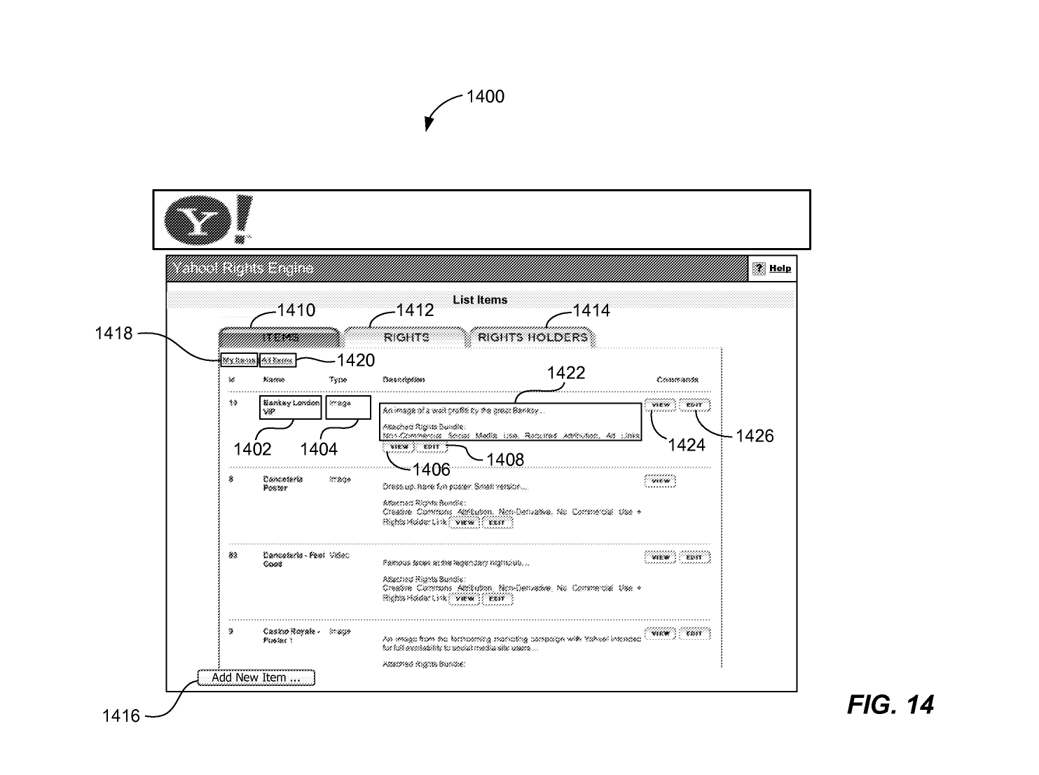

FIG. 14 depicts an example of a user interface for viewing a list of available content items according to one embodiment. FIG. 14 illustrates tabs 1410, 1412, 1414 that allow a user to navigate and view the list of items, a list of rights bundles and a list of rights holders. Access to tabs 1410, 1412 and 1414 can be authorized based on the user identifier that is interacting with user interface 1400. For example, if the user identifier is for a content consumer, the content consumer may be able to access tab 1410 to view the items listed in association with tab 1410. In addition, the user may be able to access the tab 1414 to view rights holders' information.

In another embodiment, the content consumer may not be provided access to the tab 1412. This can be done to prevent the content consumer to edit any of the information contained in the rights bundles. In another embodiment, the user may be able to access the tab 1412 with viewing rights, but not editing rights.

In one example, the items displayed in the items tab 1410 can include all of the items submitted by a rights holder or all of the items submitted by all rights holders. For example, if the user selects the button 1418, the rights holder may be able to view the items submitted by the rights holder. In addition, the rights holder may be able to select button 1420 to view all of the items submitted by all of the rights holders. Thus, if the user is simply a content consumer, and the content consumer selects on the “my items” button 1418, the content consumer will not view any items listed as part of the “my items” list because the content consumer had not submitted any content items. However, the content consumer upon selecting the button 1420 would be able to view all of the content items submitted by users such as rights holders.

The list of content items can include information associated with each content item listed as part of the user interface 1400. In one example, the information listed can include the content item name using a label 1402. In another example, the type of the content item can be listed using a label 1404. In yet another example, a description using a label 1422 can also be listed. In addition, the rights bundle associated with the content item can also be viewed as part of the description 1422. A button 1406 can permit the user to view more in detail the description in the associated rights bundle. Furthermore, a button 1408 may allow a user to edit the attached rights bundle. Of course, this option may be reserved only for those users who are viewing the items submitted by themselves. Hence, if a rights holder is viewing the content items submitted by himself, the rights holder can edit the attached rights bundle via the button 1408. In addition, a button 1424 can permit a viewer of the content items to expand the view of a selected content item to view more details regarding that content item. Also, an edit button 1426 can be provided to users who have submitted the content item. As shown in user interface 1400 regarding item 8, an edit button is not available because item 8 is not submitted by the user viewing the list of user interface 1400. As such, the user does not have any permission to change or edit any of the information related to that content item. A button 1416 can also be provided by user interface 1400 to allow a rights holder to add a new content item as previously discussed in relation to FIG. 5.

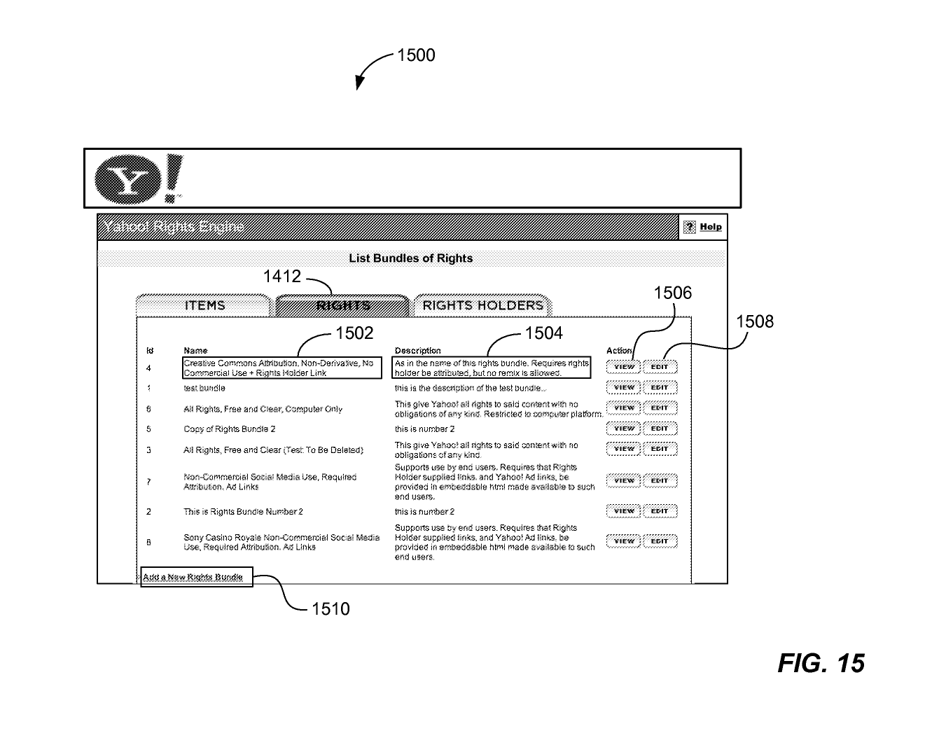

FIG. 15 depicts an example of a user interface for viewing a list of available rights bundles according to one embodiment. In one example, the list of rights bundles can be displayed once a user selects the tab 1402. As previously mentioned, the user interfacing with user interface 1500 can be a content consumer or a rights holder. The bundles of rights can be listed and displayed using information associated with each of the bundles of rights. In one example, a bundle of rights can be listed using the name on a label 1502 and the description on a label 1504. Furthermore, for each bundle of rights listed, a user can view or edit the bundle of rights. For example, the user can select a button 1506 to further view all of the restrictions, fees, obligations and any other information associated with the listed bundle of rights. Likewise, the user can select a button 1508 to edit the bundle of rights and change the rights associated with the bundle of rights, fee obligations, restrictions, devices used, territories, etc. Of course, the edit button 1508 can only be present and available for those users who have permission to alter or edit the information associated with the selected bundle of rights. In addition, a button 1510 can also be provided as part of user interface 1500 to add a new bundle of rights.

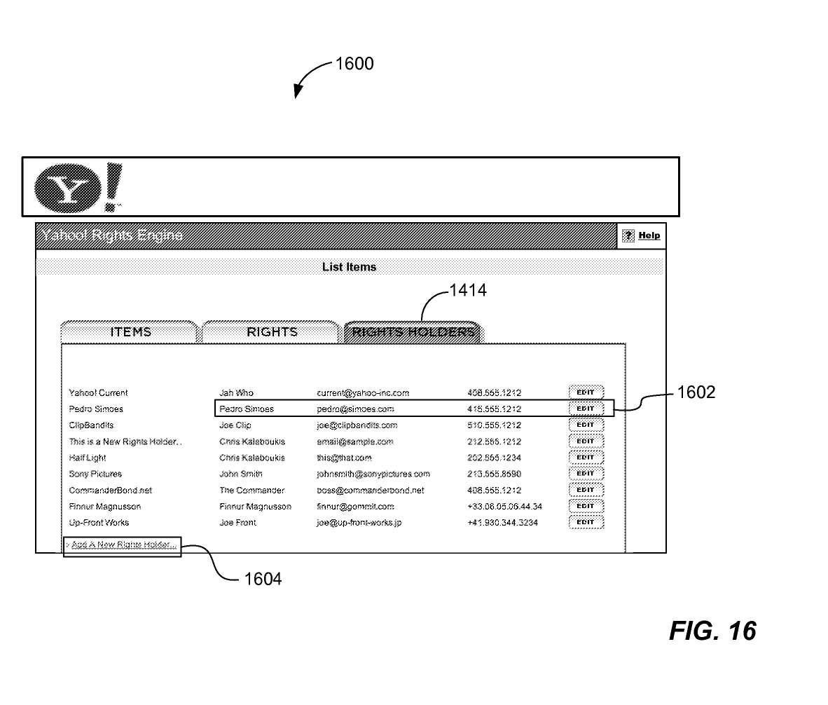

FIG. 16 depicts an example of a user interface for viewing a list of available rights holders according to one embodiment. The user can select tab 1404 in order to view a list of rights holders. In one example, the list of rights holders is a list of all of the rights holders who have submitted content items. In another example, the list of rights holders can be a list of rights holders who have not necessarily submitted content items but that have subscribed to do so in the future. User interface 1600 can be utilized by content consumers to view the contact information of rights holders in order to make additional negotiations with the rights holders. In another example, other rights holders can view the list of rights holders in order to contact them for negotiating the exchange of content items or any other assets. Contact information can be displayed as an entry 1602. The contact information can include the name and the address, telephone number, facsimile, address, or any other product information relevant to the rights holder. In addition, each entry can also include an edit button that will permit rights holders with authority or permission to edit the contact information of a specific rights holder. In addition, a button 1604 can be included as part of user interface 1600 to add a new rights holder.

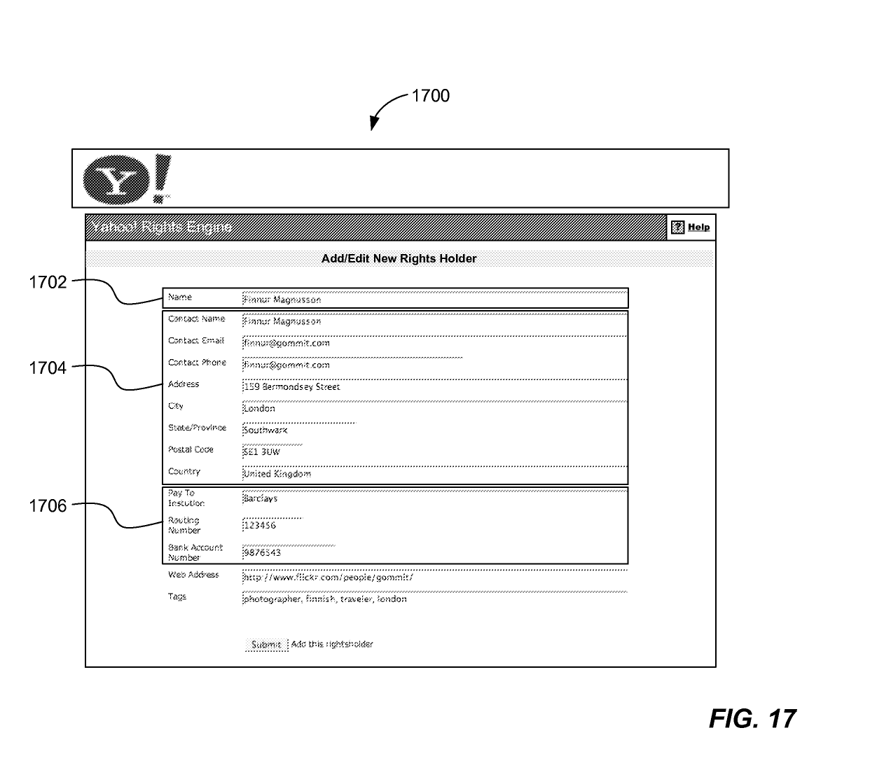

FIG. 17 depicts an example of a user interface for entering rights holder information according to one embodiment. If a user selects an edit button in the list of rights holder of user interface 1600 or an add a new rights holder button 1604, a web form or any other form can be provided to the user to edit or enter information related to a new rights holder. As it is well known in the art, other user interfaces can reference or invoke the user interface 1700. The user interface 1700 can include a name field 1702, contact information fields 1704, payment institution fields 1706 and additional information related to tags associated with the rights holder.

In one embodiment, the payment information can be automatically saved and used in order to deposit fee payment from content consumers who have submitted payment for the use of content items owned by the rights holder. Likewise, contact information of a rights holder can be displayed. This helps content consumers can contact the rights holder in order to negotiate additional deals, licenses or terms for using a content item owned by the rights holder.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions can be distributed among software applications at either the client or server level or both. In this regard, any number of the features of the different embodiments described herein may be combined into single or multiple embodiments, and alternate embodiments having fewer than or more than all of the features herein described are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

1. A method of providing a bundle of rights, comprising:
receiving, at a rights engine, data that defines a rights bundle, wherein the data that defines the rights bundle is indicative of access rights and obligations with respect to any content item to which the bundle of rights is applied; and
storing the rights bundle in a rights database, wherein the rights database is accessible to the rights holder to retrieve the rights bundle and apply the rights bundle to a content item previously received from the rights holder.

2. The method of claim 1, further comprising providing to content consumers the content item provided according to the terms of the bundle of rights.

3. The method of claim 1, wherein the content item is received either as location indicator indicative of a network address where a content item is located or as data representative of the content item.

4. The method of claim 3, further comprising storing the content item or the location indicator in association with the rights bundle.

5. The method of claim 1, wherein the bundle of rights can be applied to one or more content items such that when a content consumer receives the one or more content items, the consumer accesses the one or more content items according to terms of the rights bundle.

6. The method of claim 1, wherein the bundle of rights includes digital rights management terms.

7. The method of claim 1, wherein the rights bundle includes an indication of what permissible uses are available.

8. The method of claim 1, wherein the bundle of rights includes an obligation to display advertisements, links, licenses authorship attribution, rights holder attribution, copyright notices, or tags.

9. The method of claim 1, wherein the access rights include a license to use to content item.

10. The method of claim 1, wherein the access rights include a license to perform the content item.

11. The method of claim 1, wherein the access rights include an indication of a limited period of access.

12. The method of claim 1, wherein the access rights include a geographical limitation.

13. The method of claim 1, wherein the access rights include an indication of a rendering device limitation.

14. The method of claim 1, wherein the content item is a literary work, an intellectual property right, an electronic music file, or an electronic video file.

15. A system of providing content to consumers, comprising:
a rights engine that receives data that defines a rights bundle, wherein the data that defines the rights bundle is indicative of access rights and obligations with respect to any content item to which the bundle of rights is applied; and
a rights database that stores the rights bundle, wherein the rights holder can access the rights database and apply the rights bundle to a content item being received from the rights holder.

16. The system of claim 15, wherein the bundle of rights includes an obligation to display advertisements, links, licenses authorship attribution, rights holder attribution, copyright notices, or tags.

17. The system of claim 15, wherein the access rights include a license to use to content item.

18. The system of claim 15, the access rights include an indication of a limited period of access.

19. The system of claim 15, wherein the access rights include a geographical limitation.

20. The system of claim 15, wherein the content item is a literary work, an intellectual property right, an electronic music file, or an electronic video file.
